(19) United States
(12) Patent Application Publication
(10) Pub. No.: US 2010/0107589 A1
(43) Pub. Date: May 6, 2010

(54) RAKE HEAD HAVING HELICAL COIL

(76) Inventor: Terence Duncan MacKay, Isle of Man (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/265,952

(22) Filed: Nov. 6, 2008

(51) Int. Cl. A01D 7/00; A01D 7/06

(52) U.S. Cl. 56/400.21; 56/400.01

(57) ABSTRACT

A rake head comprising at least one substantially rigid helical coil portion and at least one resiliently deformable helical coil portion. The substantially rigid helical coil portion is supported. The deformable helical coil portion is able to flex by bending, and is compressible under the influence of external forces.

### BACKGROUND OF THE INVENTION

1. Field of the Invention

This invention relates to rakes and in particular, but not exclusively, to rakes for use in golf course bunkers.

2. Background Art

Golf courses frequently include sand traps or “bunkers”. When a player's ball lands in a bunker, golfing etiquette demands that the sand be smoothed over after the player has successfully exited the bunker. Most courses provide rakes located near to or in the bunkers for this purpose but by their very nature they are open to the prevailing weather. Moreover, existing rakes are sometimes stolen for use as garden implements. Furthermore, known bunker rakes do not level the sand in the bunker very efficiently, producing distinct furrows in the sand which can adversely affect the lie of a ball subsequently entering the bunker.

Several attempts have been made to address the shortcomings of standard rakes in respect of golf bunkers. For example, U.S. Pat. No. 5,927,057 discloses a rake having an egg-shaped head from which tines project outwardly from one surface for raking the sand and having another surface for smoothing the furrows produced by the tines.

U.S. Pat. No. 4,741,150 discloses a similar rake in which the head is reversible. However, with such rakes there is a tendency for sand to build up on the longitudinal smoothing face, thus requiring more effort to displace the unwanted build-up. Moreover, both racks are only effective when pulled towards a user.

GB 2030034 discloses a collapsible bunker rake based upon a coil spring, the ends of which are connected to supporting arms which can be used to collapse the rake structure to allow it to be stowed away in a golf bag. The pitch of the coil can be adjusted to suit the coarseness of the bunker sand but this requires a user to continually change the pitch by means of a ring which adjusts the relative inclination of the arms. However, since the rake head is adjustable, the spring forming the rake head must have a relatively high degree of flexibility. One effect of this is that the rake is only really suitable for dry sand since if the sand is wet the spring head deforms as it is pulled across the sand surface and does not provide a particularly efficient raking action.

Our own patent, GB2400295, discloses a rake head comprising a substantially rigid helical coil and means for connecting the coil to a handle. By providing a helical coil which is rigid rather than deformable, the head can be used satisfactorily with sand of different types, in particular wet sand.

On modern golf courses, bunkers can comprise a sand-impermeable membrane that is overlaid by a layer of sand approximately 100 mm deep. A problem with known rakes is that their tines can snag and rip the membrane, causing irreparable damage to the bunker. Additionally, known bunker rakes can be prone to damaging the grass adjacent the edge of the bunker due to the tines of the rake inadvertently digging into te grass as the sand is raked.

### SUMMARY OF THE INVENTION

It is an object of this invention to provide a rake that addresses one or more of the above problems, and/or to provide an improved and/or an alternative rake head.

According to a first aspect of the invention, there is provided a rake head comprising at least one substantially rigid helical coil portion and at least one resiliently deformable helical coil portion.

According to a second aspect of the invention, there is provided a rake head comprising a helical coil whose free end is bent to form a substantially straight portion.

According to a third aspect of the invention, there is provided a rake head comprising a helical coil whose final turn is of reduced diameter and/or pitch compared to the main body of the coil.

Advantageously, by providing a rake head with both substantially rigid and flexible portions, it is possible to use the rake head effectively with either wet or dry sand.

The at least one substantially rigid helical coil portion may be interposed between a pair of resiliently deformable helical coil portions. Such a configuration enables the rake head to be used effectively at, or towards, the edges of the bunker; the flexible portion being able to bend upwardly onto the surrounding grass, thereby minimizing damage thereto.

Users of rakes often throw the rake onto the ground after use. However, since the rake of the invention has flexible end portions, if the rake head lands on its end it can bounce, thereby reducing the likelihood of becoming damaged itself or indeed damaging the surrounding area, e.g. the fairway, if used on a golf course.

The rake head of the invention does not have the spiked tines of a conventional rake, which spiked tines can present a potential hazard to users. Additionally, by providing a helical coil instead of conventional spiked tines, if a user were to accidentally tread on the rake head, there is a greatly reduced likelihood of the rake handle being flipped upwards and striking the user.

The at least one substantially rigid helical coil portion and the at least one resiliently deformable helical coil portion preferably have a one-piece construction for reasons of durability and ease of manufacture. Most preferably, the at least one substantially rigid helical coil portion and the at least one resiliently deformable helical coil portion are integrally formed.

A support bar may be provided. Where provided, the support bar may be used to render a portion of a helical coil substantially rigid. The support bar may comprise a curved planar portion affixed at intervals, e.g. by welding, to the substantially rigid coil portion. Preferably, the coil portion and the support bar are manufactured of metal and are welded to one another.

Means for connecting the head to a handle is also preferably provided. The means for connecting the head to the handle may comprise a socket for receiving one end of a rake handle.

The means for connecting may be offset with respect to the longitudinal centerline of the support bar. Such a configuration enables sand to be raked when the rake head is oriented so that the edge of the support bar clears the surface of the sand. However, when the rake head is used the other way up, the edge of the support bar lies below the level of the sand and the support bar can thus be used to push the sand around.

The rake head and/or either coil portion may be manufactured of stainless steel for reasons of longevity and its ability to withstand the elements without the need for regular maintenance, e.g. painting. The metal of the rake head may be shot-blasted or shot-peened to increase its surface hardness and/or for aesthetic reasons.

The pitch of either helical coil portion may be of substantially fixed pitch, although the dimensions and/or pitch of the rake head may be adjustable.

At its ends, the end turns of helical coil portions are preferably closed so that the terminating ends of the coil do not protrude. The terminating/free end of the wire making up the end of the helix may be bent to form a substantially straight portion, which portion may, cross the longitudinal axis of the head, and/or whose terminating end may touch the penultimate turn of the helix. The final turn or turns of the helix may be of reduced diameter and/or pitch compared to the main body of the helix. Furthermore, the terminating ends of the coil are preferably arranged to face upwardly in use, e.g. towards the handle and/or away from membrane so that the ends of the coils do not snag or catch on the bunker membrane and thus rip it.

The coil may be elongate and extend along a substantially straight axis.

Optionally, the rake head may further comprise a sieve for isolating large particles, which sieve may be located within a helical coil portion of the rake head. The sieve, where provided, may be elongate and/or extend along substantially the whole length of the helical coil. The sieve may comprise a metal gauze, and may be concave in cross-section, having a V-shaped or U-shaped cross-section.

The invention also provides a rake comprising a handle attached to a rake head as previously described. The rake head or rake may be used for any one or more of the following applications: golf bunkers, horticulture, agriculture, the building industry and sporting events.

The invention also provides a kit of parts for producing a rake comprising a rake head as described above, a handle and a means for connecting the head to the handle.

By way of example only, specific embodiments of the present invention will now be described, with reference to the accompanying drawings, in which:

### BRIEF DESCRIPTION OF THE DRAWINGS

FIG. 1 is a perspective view of a rake head in accordance with the present invention;

FIG. 2 is a schematic side view of the rake head of FIG. 1 in use in a membrane-lined bunker;

FIG. 3 is a schematic side view of a variant of the rake head of FIG. 1 in use in “pushing mode”;

FIG. 4 is a schematic side view of a variant of the rake head of FIG. 1 in use in “raking mode”;

FIG. 5 is a side view of a first alternative end configuration for the rake head of the invention;

FIG. 6 is an end view of the first alternative end configuration of FIG. 5;

FIG. 7 is a side view of a second alternative end configuration for the rake head of the invention; and

FIG. 8 is an end view of the second alternative end configuration of FIG. 7.

### DETAILED DESCRIPTION OF THE PREFERRED EMBODIMENT(S)

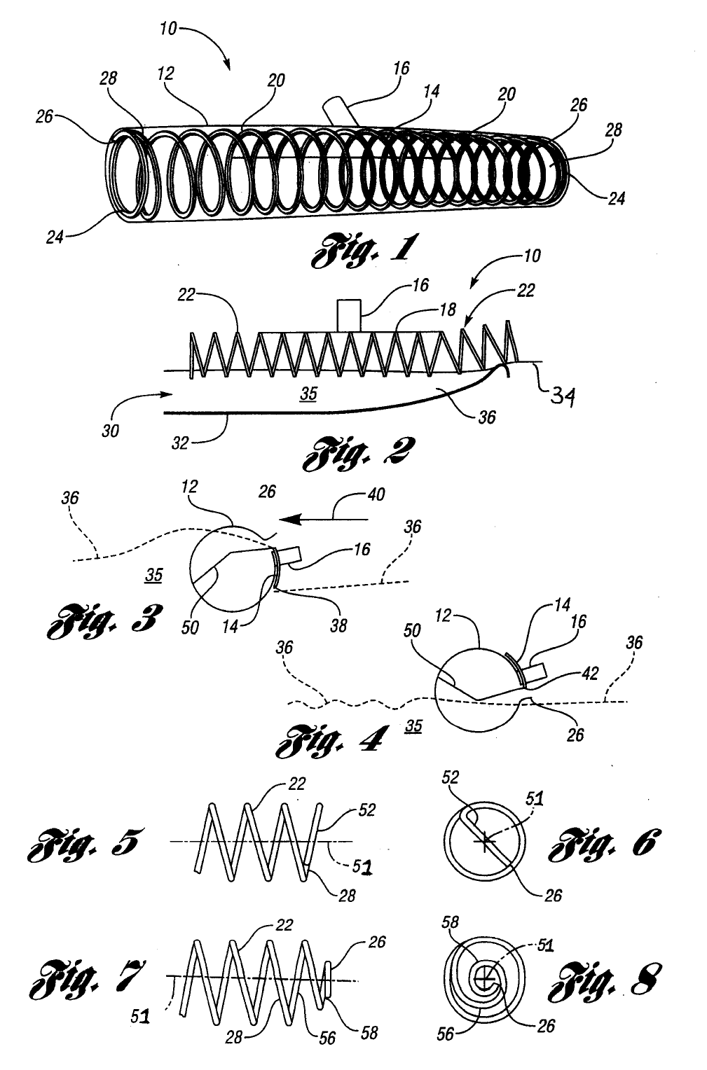

Referring firstly to FIG. 1, a rake head 10 comprises an elongate metal helix 12 of substantially constant pitch. The helix is “straight” in that it extends along a longitudinal axis.

Towards its center, the metal helix 12 is welded to an elongate metal support bar 14 to the center of which is secured a socket 16 which receives a conventional elongate rake handle (not shown).

The metal support bar 14 renders a central portion 18 of the metal helix substantially rigid. The metal helix 12 extends in both directions beyond the ends 20 of the support bar 14. These unsupported portions 22 of the metal helix 12 are resiliently deformable inasmuch as they can bend, twist and compress under the influence of external forces.

The end turns 24 of the metal helix 12 are closed, i.e. the last turn of the helix lies in a plane substantially perpendicular to the longitudinal axis of the helix so that the terminating ends 26 of the helix 12 touches the helix 12 at a point on the penultimate turn 28. The terminating ends 26 of the helix lie at a radial position that corresponds to the position of the socket 16 such that the terminating ends 26 are kept out of the sand during normal use of the rake head 10. This minimizes the likelihood of the terminating ends 26 snagging and/or ripping the bunker membrane.

In the embodiment illustrated, the head 10 is approximately 58 cm in length and the diameter of the metal helix 12 is approximately 9 cm along the whole of its length. The pitch of the helix 12 is approximately 3 cm per revolution. It will be appreciated that the length, diameter and/or pitch of the metal helix 12 may be altered. Additionally or alternatively, the helix need not necessarily be manufactured of metal—durable, weather resistant materials might be used, such as plastics.

In use, the rake head 10 is used in an identical manner to a conventional rake head.

However, it has been found that the interaction of the helical “tines” with the sand in a bunker produces a smooth and relatively furrow-free surface. It is believed that this results from the fact that the helix effectively forms curved tines which are in addition inclined to the normal raking direction (the longitudinal axis of the handle) and which therefore tend to shift material laterally (along the longitudinal axis of helix) as the head is drawn through the sand. Moreover, the use of a helix allows the rake to be used in both directions.

In FIG. 2, the rake head 10 is being used to rake a bunker 30. The bunker 30 comprises a shallow hole dug into the ground that has been lined using a flexible polymeric membrane 32. The bunker is surrounded by a grass border 34 and the hole is filled, up to the approximate level of the grass border 34 by soft sand 35.

In use, a user drags a rake comprising a rake head 10 as previously described, over the surface 36 of the sand 35 to smooth it. When the user rakes the sand 35 close to the border 34, the flexible end portion 22 of the rake head 10 is able to flex upwardly to ride over the grass, while the substantially rigid portion 18 and the other flexible portion 22 can continue to smooth the sand surface 36.

Because the rake head uses a helical coil rather than spiked tines, the turns of the coil present a smooth curve, at a shallow angle, to the sand 36, membrane 31, and grass 34 surfaces. The “tines” of the present rake head 10 are thus able to skim over the sand 36, membrane 32 or grass 34 surface without digging in, which minimizes the likelihood of causing damage.

Because the rake head has flexible end portions, it can also conform to the shape of the perimeter of the bunker, which is not normally straight-sided when viewed from above. Advantageously, this means that the sand can be raked all the way to the edge of the bunker simply by pushing the rake head into the edge, and raking towards the center of the bunker.

In FIGS. 3 and 4, it can be seen that the position of the socket 16 is asymmetric, i.e. offset with respect to, the longitudinal midline of the support bar 14, which enables the rake head 10 to be used in “pushing” or “raking” modes depending on its orientation relative to the sand 35.

In FIG. 3, the rake head 10 is being used in pushing mode in which a first long edge 38 lies below the level of the sand 36 ahead of the rake head 10. Thus, as the rake head is moved in the direction indicated by arrow 40, sand 35 is pushed along by the rake head 10.

In FIG. 4, the same rake head 10 as that shown in FIG. 3 has been inverted such that a second long edge 42 of the support bar 14 now clears the surface of the sand 36. This way up, just the “tines” of the rake head, and not the support bar 14, protrude into the sand 35 so that the rake head 10 merely smooths the sand's surface 36, rather than bodily moving it along.

The embodiment of FIGS. 3 and 4 additionally comprises a stone sieve 50 arranged within the metal helix 12. The stone sieve 50 comprises an elongate sheet of metal gauze formed into a V-shape in cross-section and arranged with its longitudinal axis parallel to the longitudinal axis of the helix. The sieve 20 is welded to the helix at the locations where it touches the helix.

As the rake head is drawn through the sand, any stones or other foreign objects dislodged by the rake and falling onto the top of the sieve 50 are retained on the upper surface, thanks to its cross-sectional V-shape. The sand is allowed to fall through the sieve and the sieve does not interfere with the raking action. Any foreign objects retained by the sieve can be tipped out of either end of the rake head.

A variation of the embodiment as illustrated in FIGS. 3 and 4 includes the sieve 50 having a U-shaped cross section rather than a V-shaped one.

FIGS. 5 and 6 show a first alternative configuration of the invention. Whereas in the foregoing embodiment, the end turns 24 of the metal helix 12 were closed such that the last turn of the helix lay in a plane substantially perpendicular to the longitudinal axis of the helix, in the embodiment shown in FIGS. 5 and 6, the free end 26 of the wire making up the helix 12 is bent to form a straight portion 52 that crosses the longitudinal axis 50 of the head 10 whose end 26 touches the penultimate turn 28 of the helix.

In FIGS. 6 and 7, a second alternative configuration of the invention is shown in which the last two turns 56, 58 are of increasingly reduced diameter as compared to the main body of the helix 12. The free end 26 of the wire making up the helix forms a closed turn in which the last turn of the helix lies in a plane substantially perpendicular to the longitudinal axis 50 of the helix 12.

In both the first and second alternative embodiments of the invention, the ends of the helix 12 are raised above the level of the sand 36, which reduces the likelihood of uneven raking that may occur at or towards the ends of the rake head.

Nevertheless, it will be observed that the terminating ends 26 of the helix lie at a radial position that corresponds to the position of the socket 16 such that the terminating ends 26 are kept out of the sand during normal use of the rake head 10. This minimizes the likelihood of the terminating ends 26 snagging and/or ripping the bunker membrane.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A rake head comprising at least one supported substantially rigid helical coil portion in a central region of the rake head and at least one unsupported resiliently deformable helical coil portion extending from the rigid helical coil portion. a handle and means for connecting the rake head to the handle.

2. A rake head as claimed in claim 1, wherein the at least one substantially rigid helical coil portion is interposed between a pair of resiliently deformable helical coil portions.

3. A rake head comprising a helical coil having one or more free ends, at least one of the one or more free ends being bent to form a substantially straight portion.

4. A rake head as claimed in claim 3, wherein the substantially straight portion crosses a longitudinal axis of the rake head.

5. A rake head as claimed in claim 3, wherein one of the one or more free ends includes a helical section that touches a penultimate turn in one of the free ends.

6. A rake head as claimed in claim 1, wherein at least one of the at least one unsupported helical coil portions has a final turn of a reduced diameter.

7. A rake head as claimed in claim 1, further comprising a support bar.

8. A rake head as claimed in claim 7, wherein the support bar comprises a curved planar portion affixed at intervals to the at least one substantially rigid helical coil portion.

9. A rake head as claimed in claim 7, wherein the support bar is secured to the at least one substantially rigid helical coil portion.

10. (canceled)

11. A rake head as claimed in claim 10, wherein the means for connecting the rake head to the handle comprises a socket for receiving one end of the handle.

12. A rake head as claimed in claim 7, further comprising means for connecting the rake head to a handle, the means for connecting being offset with respect to a longitudinal centerline of the support bar.

13. A rake head as claimed in claim 1, wherein one of the helical coil portions includes at least some coils that are of a substantially fixed pitch.

14. A rake head as claimed in claim 1, wherein the at least one resiliently deformable helical coil portion has an end in which turns are closed.

15. A rake head as claimed in claim 1, wherein a terminating end of a helical portion touches a penultimate turn of the helix.

16. A rake head as claimed in claim 1, wherein a final turn of the deformable helical portion is of a reduced pitch compared to the rigid helical coil portion.

17. A rake head as claimed in claim 1, wherein terminating ends of the at least one deformable coil portions are arranged to face upwardly in use.

18. A rake head as claimed in claim 1, wherein the rake head further comprises a sieve for isolating large particles.

19. A rake head as claimed in claim 18, wherein the sieve is located within a helical coil portion of the rake head.

20. A rake head assembly comprising a rake head with at least one supported substantially rigid helical coil portion in a central region of the rake head and at least one unsupported resiliently deformable helical coil portion extending from the rigid helical coil portion, and a handle attached to a rake head.

21. A kit for assembling a rake comprising a rake head with at least one supported substantially rigid helical coil portion in a central region of the rake head and at least one unsupported resiliently deformable helical coil portion extending from the rigid helical coil portion, a handle and means for connecting the rake head to the handle.

22. A rake head comprising at least one supported substantially rigid helical coil portion in a central region of the rake head and at least one unsupported resiliently deformable helical coil portion extending from the rigid helical coil portion so that the rake head can be effectively used in wet or dry sand and at or towards edges of a bunker, the at least one deformable coil portion being able to bend upwardly onto surrounding grass, thereby minimizing damage thereto.
